(19) United States
(12) Patent Application Publication
(10) Pub. No.: US 2016/0364531 A1
(43) Pub. Date: Dec. 15, 2016

(54) PHYSICIAN STUDY MANAGER METHOD, SYSTEM, AND APPARATUS

(71) Applicant: Somnoware Healthcare Systems, Charlotte, NC (US)

(72) Inventors: Subath KAMALASAN, Charlotte, NC (US); Parijat BHATTACHARJEE, Charlotte, NC (US); Jinesh J. JAIN, Charlotte, NC (US)

(73) Assignee: Somnoware Healthcare Systems, Charlotte, NC (US)

(21) Appl. No.: 15/179,238

(22) Filed: Jun. 10, 2016

Related U.S. Application Data
(60) Provisional application No. 62/173,745, filed on Jun. 10, 2015.

(51) Int. Cl. G06F 19/00; H04L 29/06; G06Q 10/06

(52) U.S. Cl. CPC G06F 19/325; G06F 19/327; G06Q 10/0633; G06F 19/3425; G06F 19/345; G06F 19/363; H04L 63/102; G06F 19/328

(57) ABSTRACT

A Physician Study Manager may be a centralized or de-centralized data management system for medical industries, such as the sleep medicine and wellness industry. The manager may be administered by a web portal and offered as a software service. Data may be collected from relevant stakeholders of the sleep medicine and wellness industries in coordination with capable medical diagnostic equipment. The manager may improve medical care coordination by automating the workflow of medical processes in addition to improving a patient's treatment through streamlined data visualization and processing, record retainage, and diagnostic reporting. The manager may manage the needs of everyone involved in the diagnosis, treatment, and care of sleep related conditions by providing access to patient information. Users may generate diagnostic and therapy reports, and transmit them to external entities, such as insurance or medical equipment providers, directly from the manager. The software may feature electronic security measures.

### CROSS-REFERENCE TO RELATED APPLICATIONS

This application claims priority from U.S. Provisional Patent Application No. 62/173,745, filed on Jun. 10, 2015, entitled “METHOD, SYSTEM, AND APPARATUS FOR PHYSICIAN STUDY MANAGER,” the entire contents of which are hereby incorporated by reference.

### BACKGROUND

Medical professionals and physicians that work at medical facilities, and the support systems that run those same medical facilities, have traditionally been managed and maintained on-site by the respective medical facility out of which they operate. As such, it typically falls to the medical facility to manage the scheduling of patients and the medical records and procedures associated with those patients, such as tests or testing records of patients, physician-performed diagnostic analyses, physician-generated reports, and patient recommendations. This can be a costly and inefficient burden for the medical facility, and for any medical professionals that may be involved with the procedure.

Insurance requirements and government regulations have additionally burdened the medical professional community with further records to manage; medical facilities now must manage a patient's referral letters as issued from a primary care doctor, electronic health records, demographics of the patients that have received services, and pharmaceutical and medical device prescriptions. Physicians are often burdened with the time consuming tasks of analyzing vast amounts of patient data and transforming this data into reports that may further require submission to insurance organizations to justify expenditures. The reporting, tracking, scheduling, and management of the day to day operations of a medical facility are an arduous, burdensome process.

The volume of information, along with the various levels of confidentiality and security required by law, have made it difficult for medical professionals to manage a patient database, or take part in business management processes, cost-effectively and efficiently. Medical professionals need to spend a significant amount of time processing the sheer volume of information that is sent their way, and even more time ensuring that they comply with all applicable legal standards, further burdening a field that is already overstretched. Worse still, such processing is often highly duplicative of work that has already been completed by another medical professional somewhere else, such as a patient's previous physician; this not only means that the patient will waste money and time having physicians performing work that has already been completed, but can mean that when information is shared between medical professionals or medical facilities, substantial efforts must be devoted to separating new and useful patient data from old and duplicative patient data. The management costs and hardships medical professionals experience have additionally burdened patients by increasing the costs of healthcare, and the time required to schedule medical appointments.

The medical industry, particularly the sleep wellness medical industry, has lacked clear communication between physicians, other medical providers, and insurers. This has hindered the delivery and quality of care that patients receive, slowed insurance claim processing through a lack of communication and coordinated documentation, and hindered payments receivable for physicians, testing facilities, technicians, insurance companies, and durable medical equipment providers.

These inefficiencies also serve as an obstacle to other reform in the medical industry. A growing topic of interest in the medical industry is “personalized medicine,” a medical model in which treatments are specifically tailored to patients or groups of patients based on the characteristics of the patients or the anticipated responses each patient will have to the treatment. For example, a medical condition of a first patient may be most effectively treated by a first treatment regimen or a particular drug, while the same medical condition in a second patient may be most effectively treated by a somewhat different treatment regimen, or a different drug or combination of drugs. Personalized medical treatments, while typically of greater effectiveness than more standardized medical treatments, rely on accurate information being available about the patient in question and the anticipated responses that the patient will have to a given treatment. The information that is typically required in order to structure a personalized treatment regimen (such as DNA or RNA sequences, or protein levels) is typically fairly difficult to collect and interpret, typically costing upwards of a thousand dollars per patient even in a best-case scenario. Often, because of communication inefficiencies, this information is not effectively used by medical professionals even when it exists, significantly reducing the benefit to the patient of collecting the information in the first place.

### SUMMARY

Accordingly, a comprehensive system directed at assisting physicians in managing the workflow processes of a patient's treatment may be provided. Such a system may improve the efficiency of the medical industry, particularly the sleep wellness portion of the medical industry, by improving communications and transfers of records between healthcare providers, reducing duplicative work, and facilitating the construction of patient medical reports and statistical analytics. Such a system may also improve communications between medical practitioners and health insurance providers, improving claim processing time by making it easier to transmit the appropriate documentation and standardizing documentation submissions. Such a system may also improve communications between medical practitioners and medical equipment providers, streamlining the ordering process and reducing the chances of miscommunication.

According to an exemplary embodiment, a Physician Study Manager may be a centralized or de-centralized data management system targeted most specifically at the medical industries, such as the sleep medicine and wellness industry. The manager may be administered by a web portal and offered as a software service. Data may be collected from relevant stakeholders of the sleep medicine and wellness industries in coordination with capable medical diagnostic equipment. The manager may improve medical care coordination by automating the workflow of medical processes in addition to improving treatment of a patient through streamlined data visualization and processing, record retainage, and diagnostic reporting. The manager may manage the needs of all parties involved in the diagnosis, treatment, and care of sleep related conditions by providing an unprecedented level of access to patient information. This access may create an integrated sleep wellness database. Patients managed by the Physician Study Manager may be tracked from referral, through treatment, and post treatment. Users may easily generate diagnostic reports, and transmit them to external entities, such as insurance or medical equipment providers, directly from the manager. The Physician Study Manager may sort a patient by their treatment status thereby eliminating the possibility that a particular patient may stagnate in one particular status. The Physician Study Manager may ensure that a patient completes the treatment process and receives effective medical care. The software may feature electronic security measures to protect relevant electronic information. The Physician Study Manager may be HIPPA compliant and feature additional electronic security measures to protect relevant electronic information.

According to an exemplary embodiment, the Physician Study Manager may have enhanced functionalities that allow a physician to view patient data, such as a sleep assessment performed in a medical facility or by outpatient care. The Physician Study Manager may run as a software as a service platform with a web-portal or natively on the users local computer processor. The Physician Study Manager may further be optimized to run on a local network. The manager may generate an autonomous report based off the data of a patient. The report may additionally be customizable by user defined preferences and edited directly within the report. The manager may also send patient reports and recommendations to other relevant stakeholders such as insurance entities and medical device providers.

According to an exemplary embodiment, a computer-implemented health data management system may be disclosed. Such a system may include a processor and a memory, and may implement a physician study management portal accessible by a credentialed user from a standard browser. The memory may be arranged to cause the computer to carry out the following steps: receiving, via a Web portal, medical data of a patient; matching, with a processor, the medical data of the patient with a profile of the patient, and associating the medical data and the profile of the patient in the memory; identifying, with a processor, a status indication of the profile of the patient, the status indication providing an indication of the status of one or more medical tests conducted on the patient; when the status indication indicates that at least one of the medical tests conducted on the patient has yet to be interpreted by a physician, identifying, with a processor, a physician of the patient, and displaying, on a display, a medical test result of a patient; receiving, from a user interface, an interpretation of a medical test result; updating, with a processor, the status indication of the profile of the patient; and generating and issuing a report for the patient comprising the medical data of the patient and the interpretation of the medical test result.

According to another exemplary embodiment, a method for management of medical data may be disclosed. Such a method may include: uploading, from a user interface, to a computer-implemented health data management system having a processor and a memory, medical data of a patient; wherein the health data management system is configured to: match, with the processor of the health data management system, the medical data of the patient with a profile of the patient, and associating the medical data and the profile of the patient in the memory of the health data management system; identify, with the processor, a status indication of the profile of the patient, the status indication providing an indication of the status of one or more medical tests conducted on the patient; and when the status indication indicates that at least one of the medical tests conducted on the patient has yet to be interpreted by a physician, identify, with a processor, a physician of the patient, and displaying, on a display, a medical test result of a patient; wherein the method further includes uploading, from a user interface, to the health data management system, an interpretation of a medical test result; wherein the health data management system is further configured to: update, with the processor, the status indication of the profile of the patient; and generate and issue a report for the patient comprising the medical data of the patient and the interpretation of the medical test result.

According to another exemplary embodiment, a computer-implemented health data management apparatus may be disclosed. Such an apparatus may include a computer having a processor and a memory and implementing a physician study management utility accessible by a credentialed user from a user interface. The memory may be a non-transitory computer readable medium having code arranged to cause the computer to carry out the following steps: receiving, on the health data management apparatus, from a local network, medical data of a patient; matching, with the processor, the medical data of the patient with a profile of the patient, and associating the medical data and the profile of the patient in the memory; identifying, with the processor, a status indication of the profile of the patient, the status indication providing an indication of the status of one or more medical tests conducted on the patient; when the status indication indicates that at least one of the medical tests conducted on the patient has yet to be interpreted by a physician, identifying, with the processor, a physician of the patient; displaying, on a display of the apparatus, a request for the input of the physician of the patient; authenticating, with the processor, a credential of the physician of the patient; and displaying, on a display of the apparatus, a medical test result of a patient; receiving, from the user interface, an interpretation of a medical test result; updating, with the processor, the status indication of the profile of the patient; generating and issuing a report for the patient comprising the medical data of the patient and the interpretation of the medical test result; and sharing the report on the local network.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

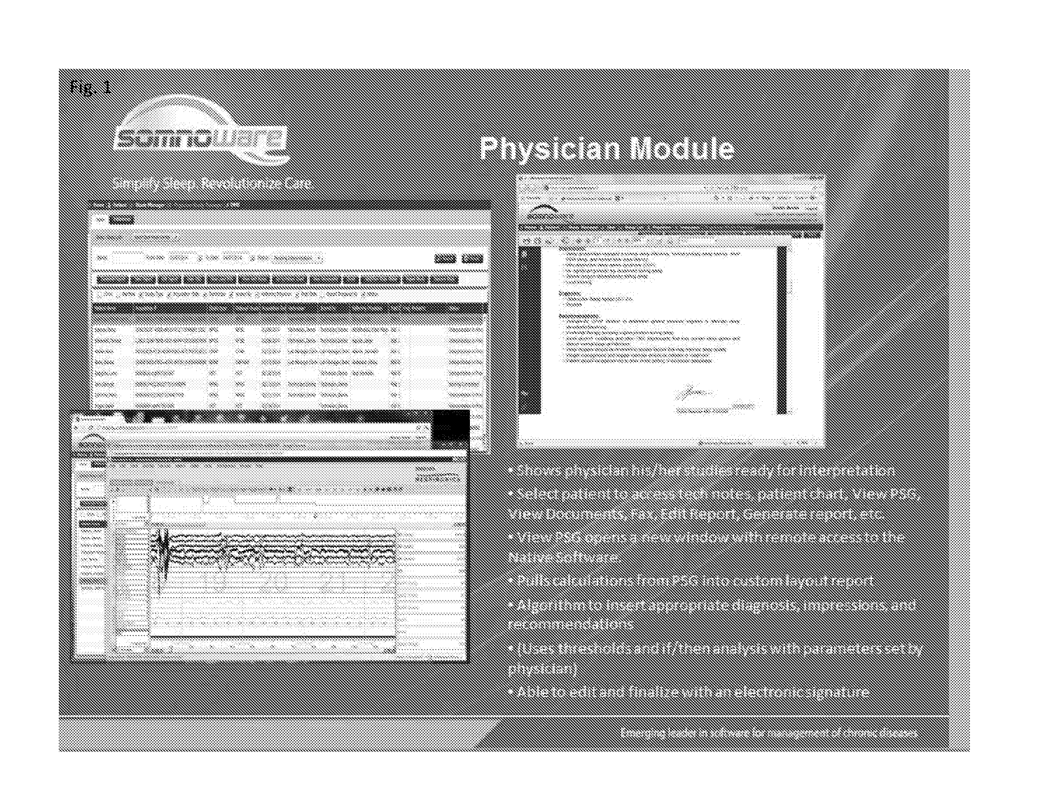

Exemplary FIG. 1 displays an exemplary embodiment of the Dashboard of a Physician Study Manager;

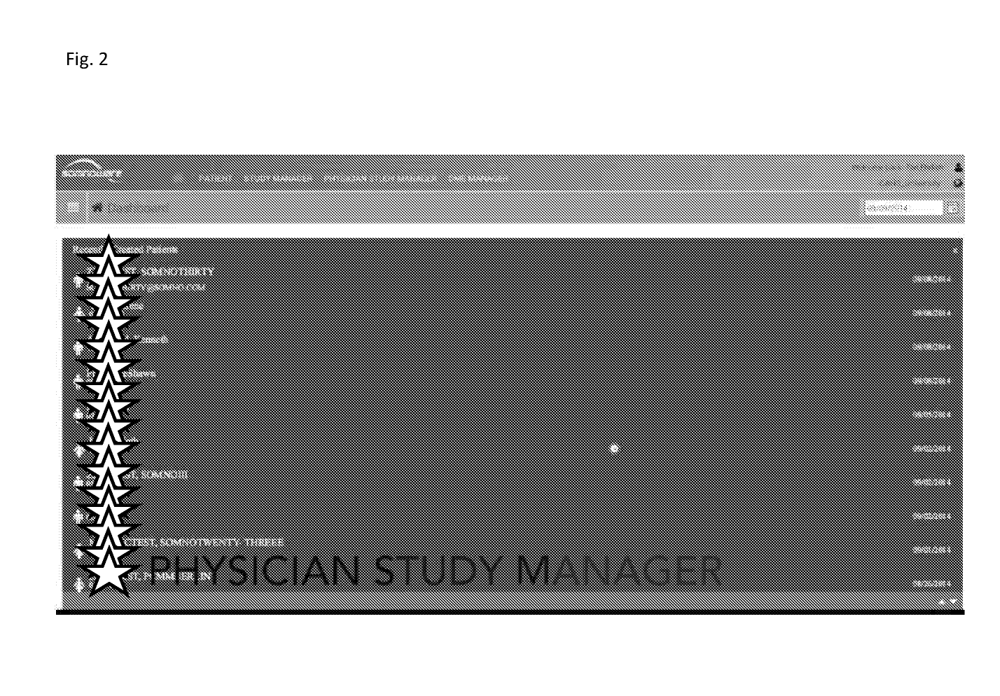

Exemplary FIG. 2 displays an exemplary embodiment of the Dashboard of a Physician Study Manager;

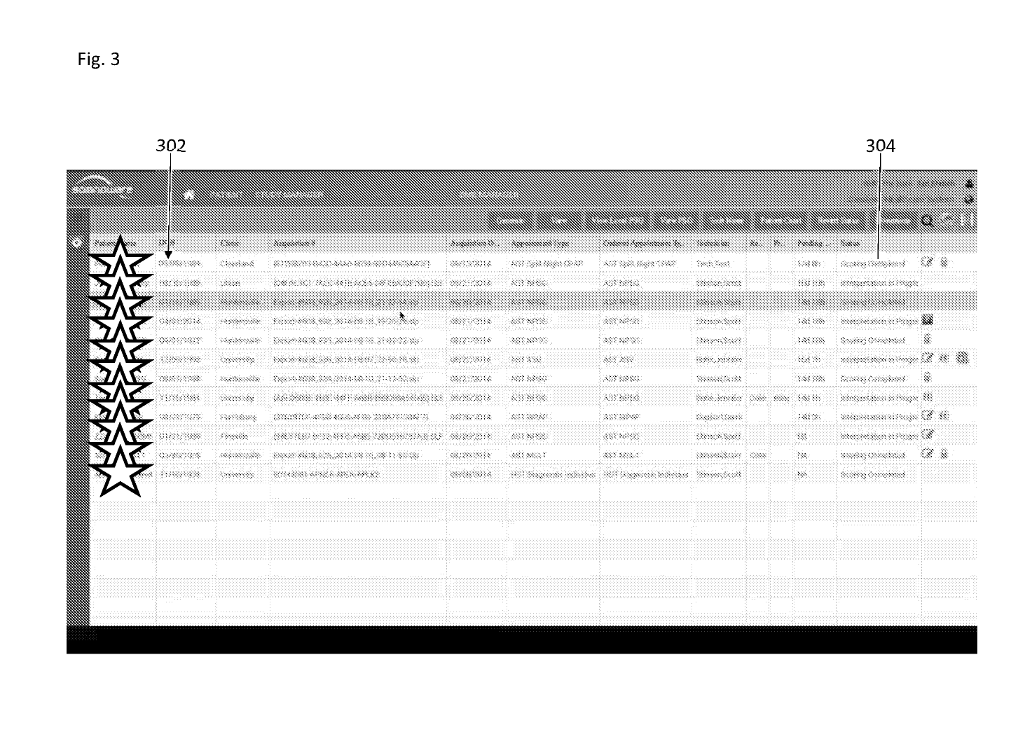

Exemplary FIG. 3 displays an exemplary embodiment of the Dashboard of a Physician Study Manager;

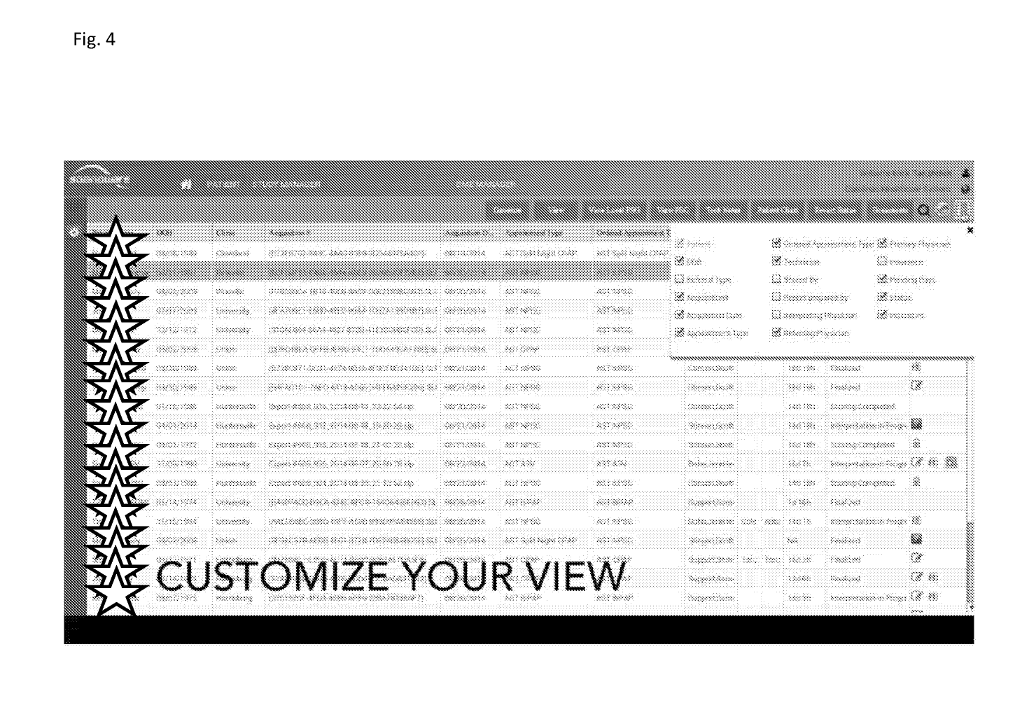

Exemplary FIG. 4 displays an exemplary embodiment of the Dashboard of a Physician Study Manager;

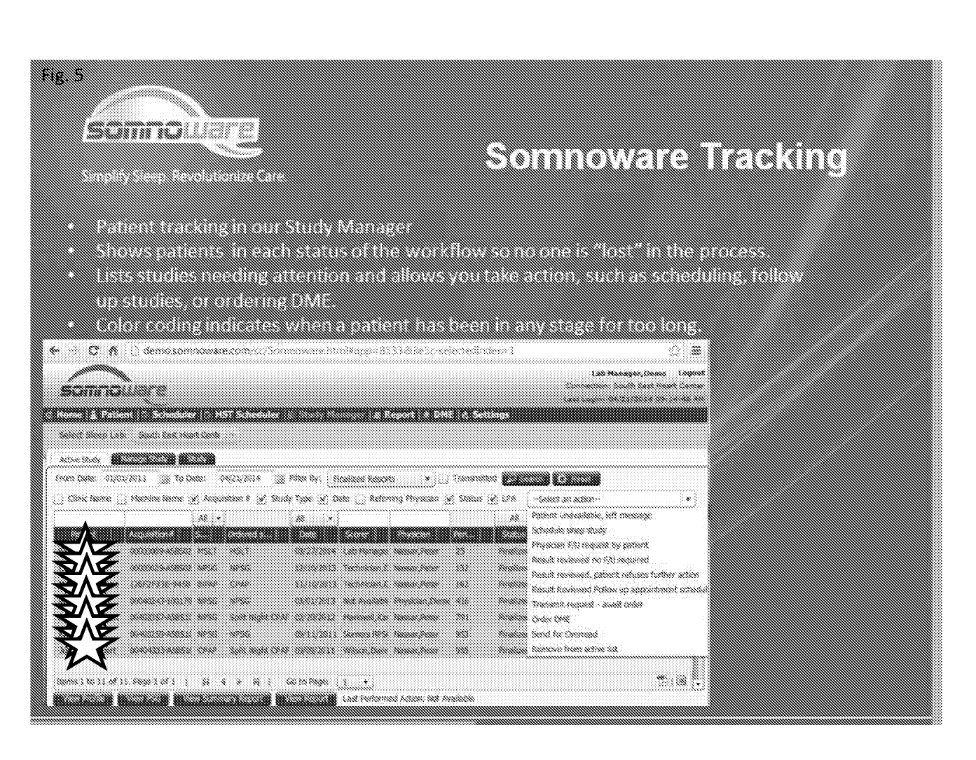

Exemplary FIG. 5 displays an exemplary embodiment of the Dashboard of a Physician Study Manager;

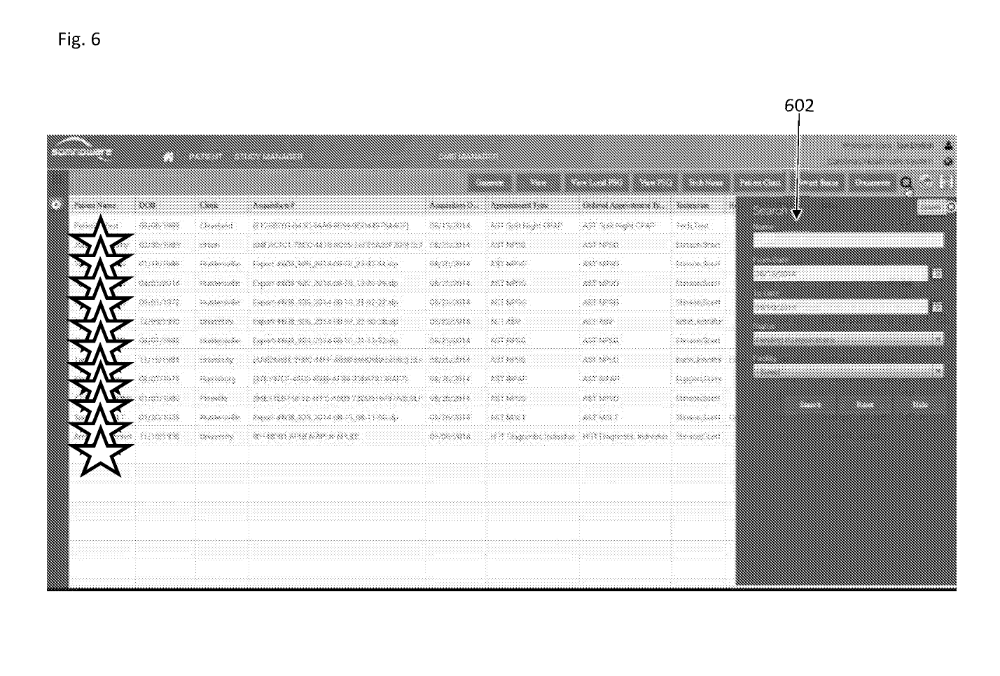

Exemplary FIG. 6 displays an exemplary embodiment of the Dashboard of a Physician Study Manager;

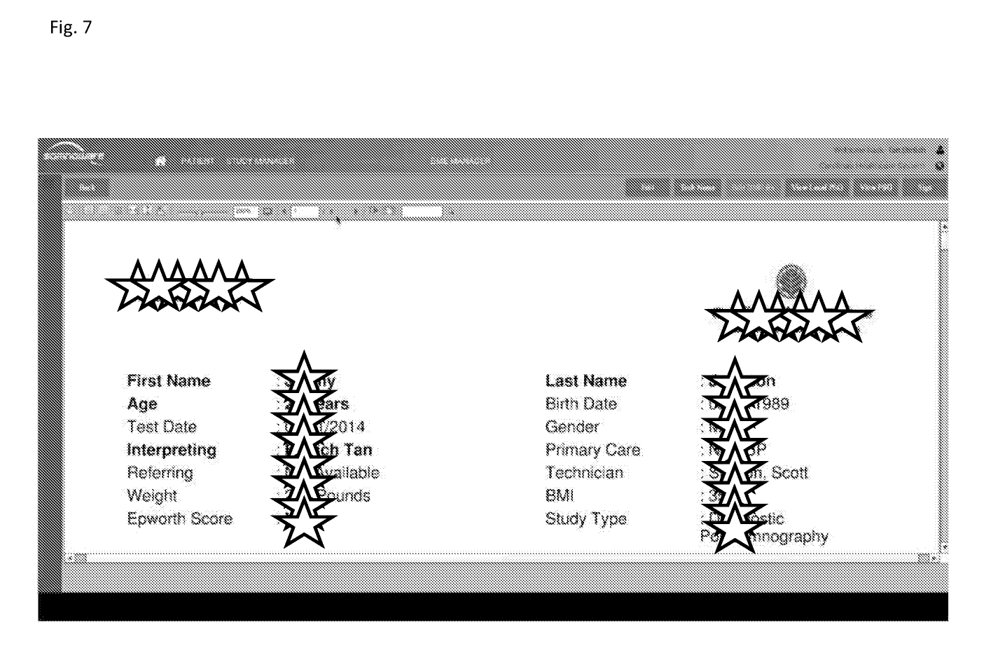

Exemplary FIG. 7 displays an exemplary embodiment of a report generated by a Physician Study Manager;

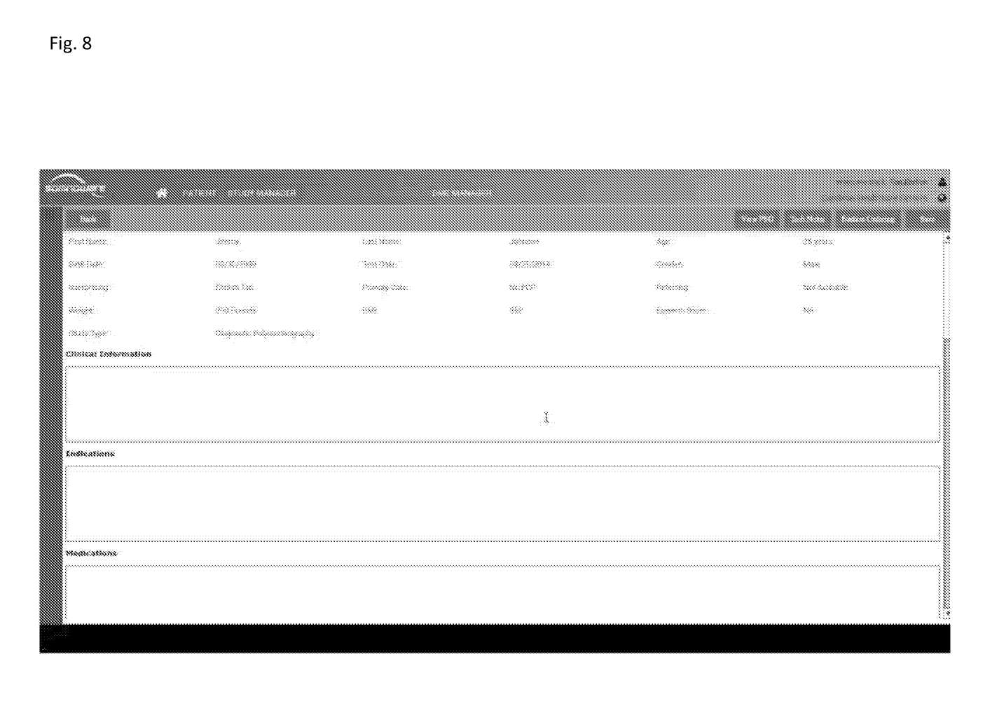

Exemplary FIG. 8 displays an exemplary embodiment of a report generated by a Physician Study Manager;

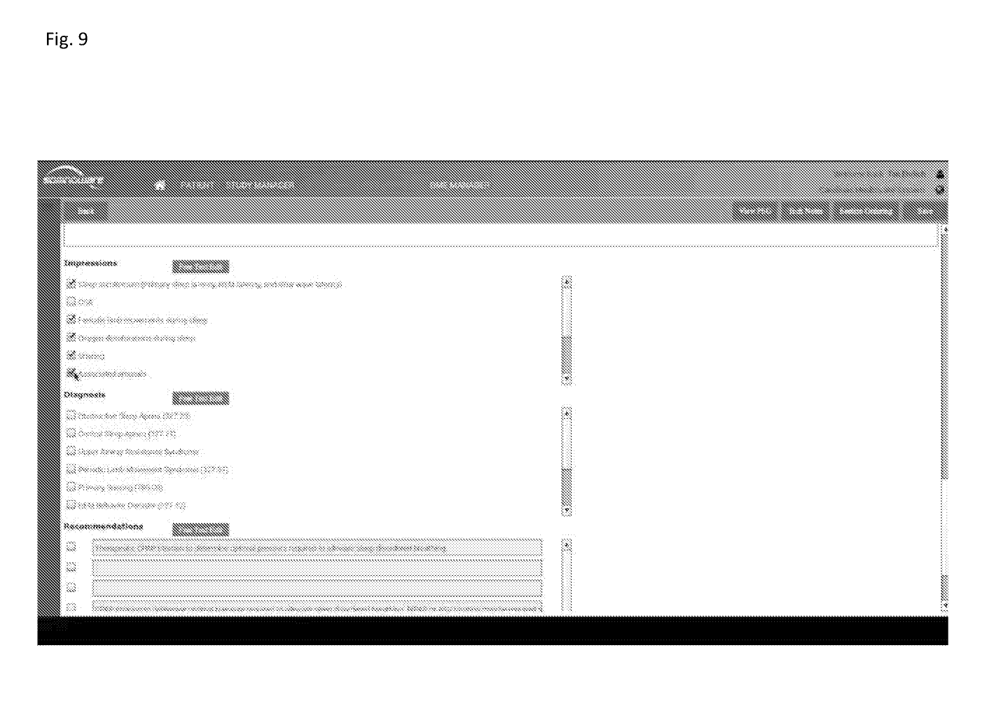

Exemplary FIG. 9 displays an exemplary embodiment of a report generated by a Physician Study Manager;

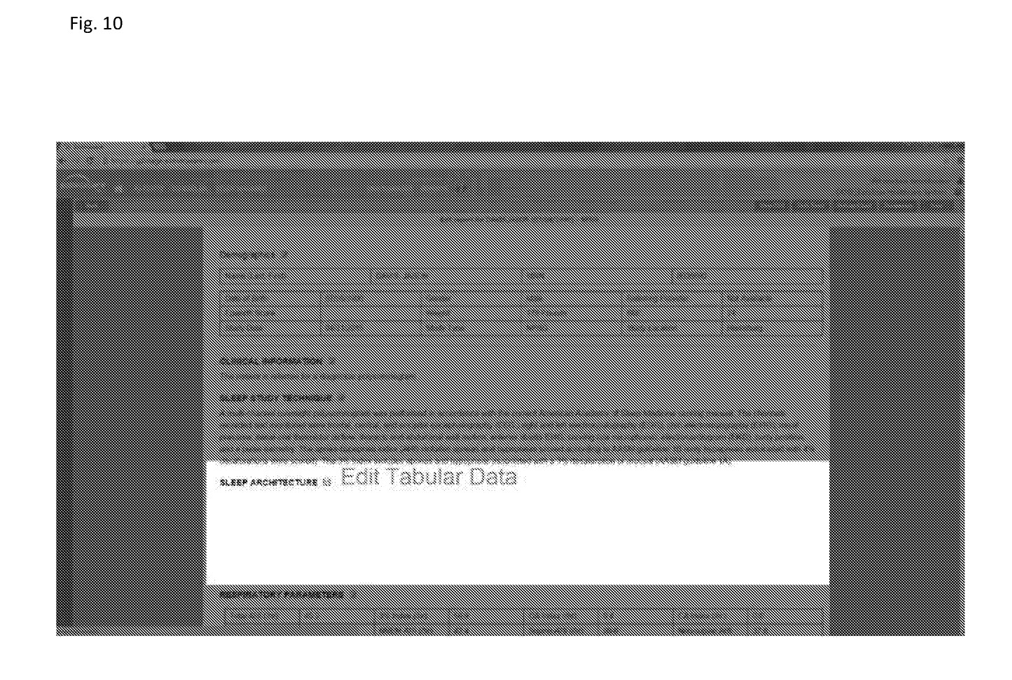

Exemplary FIG. 10 displays an exemplary embodiment of a report generated by a Physician Study Manager;

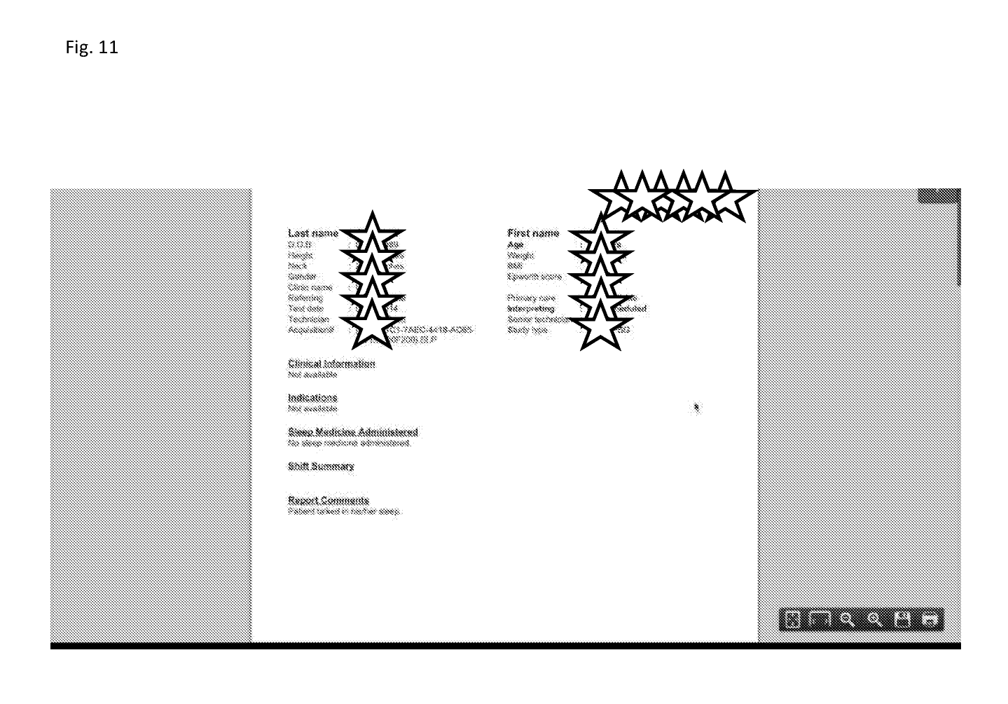

Exemplary FIG. 11 displays an exemplary embodiment of a report generated by a Physician Study Manager;

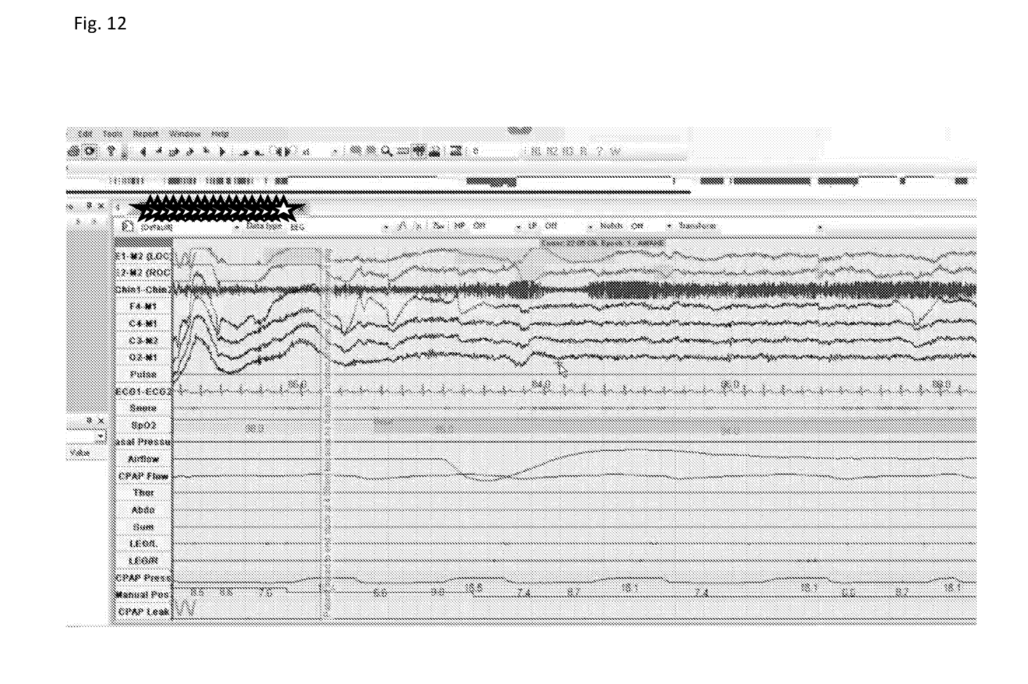

Exemplary FIG. 12 displays an exemplary embodiment of a report generated by a Physician Study Manager;

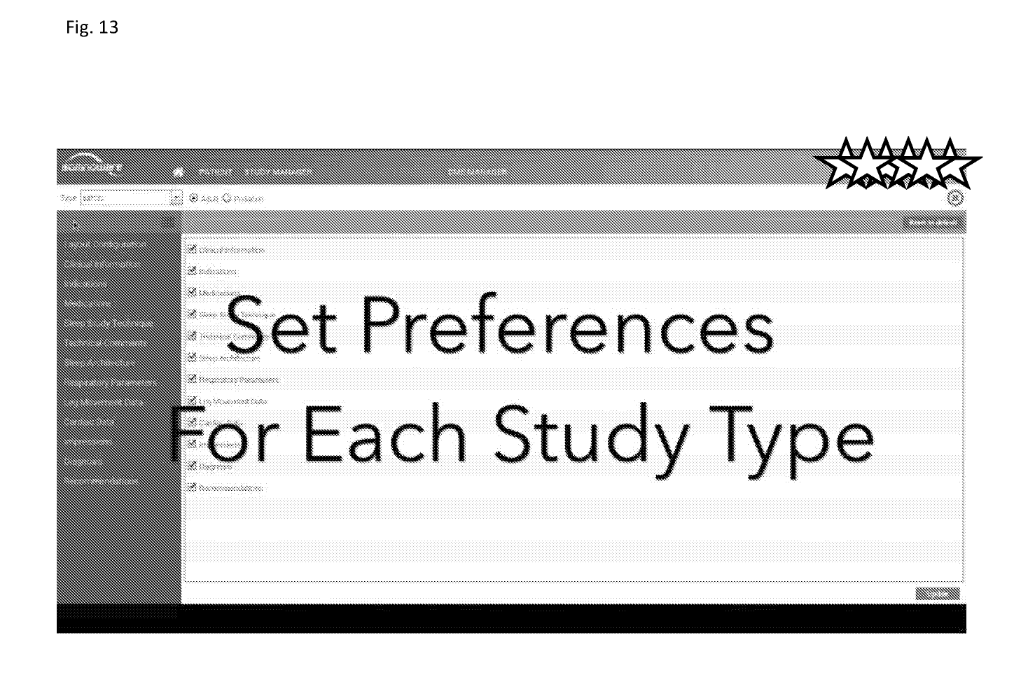

Exemplary FIG. 13 displays an exemplary embodiment of a preferences utility of a Physician Study Manager;

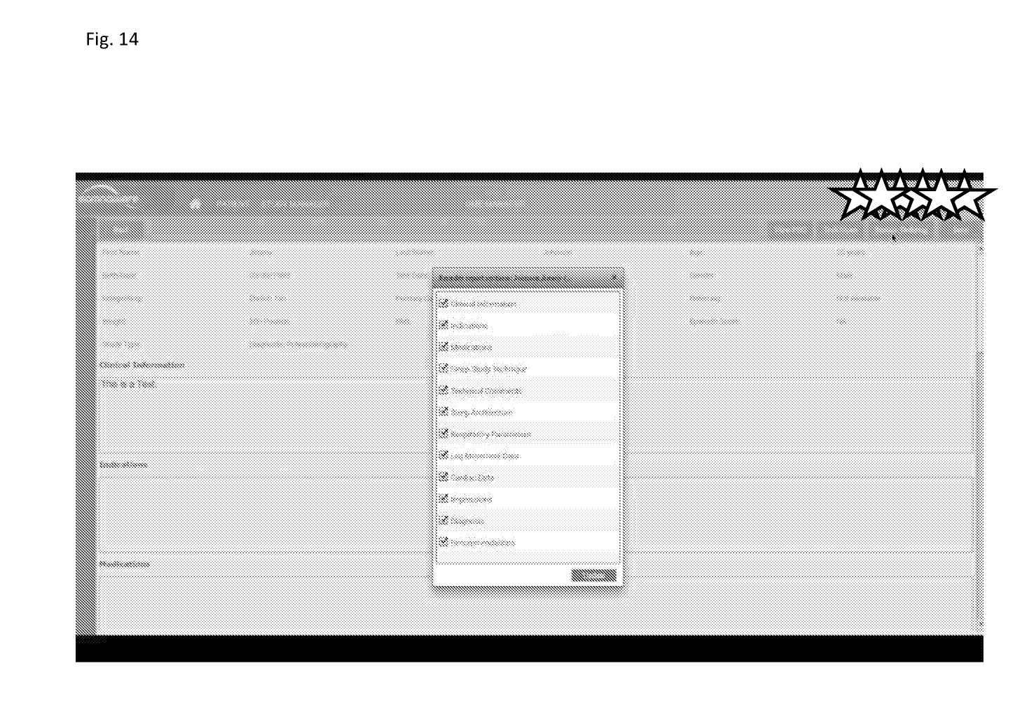

Exemplary FIG. 14 displays an exemplary embodiment of a preferences utility of a Physician Study Manager;

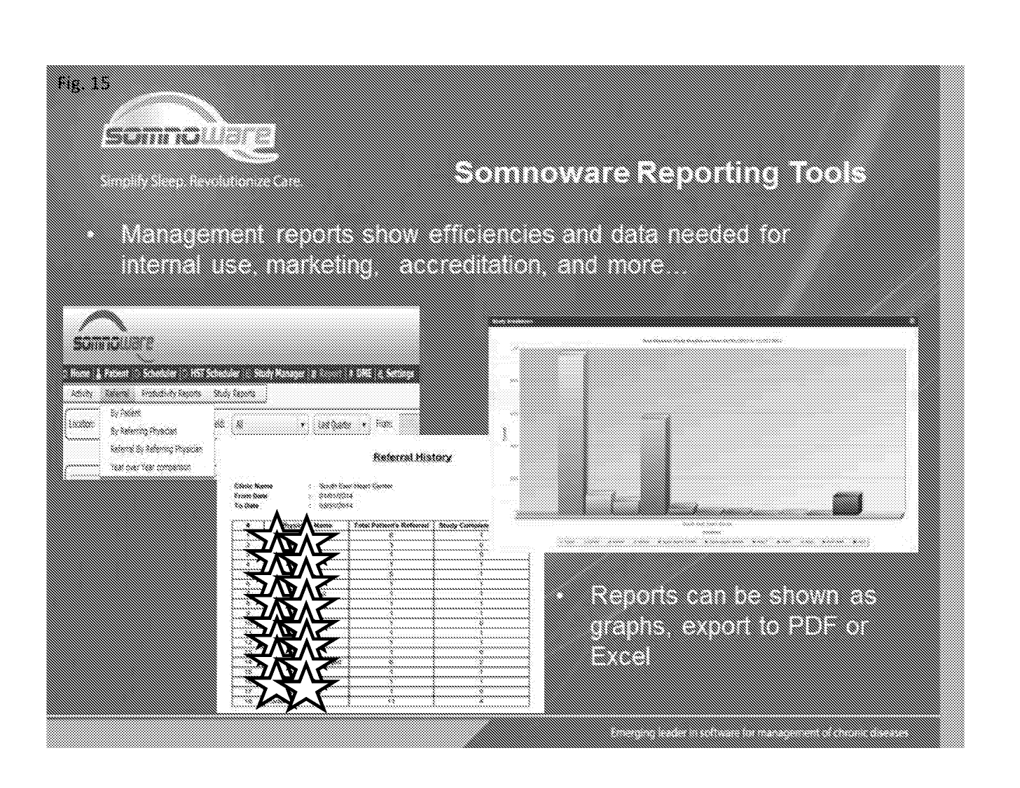

Exemplary FIG. 15 displays an exemplary embodiment of a preferences utility of a Physician Study Manager;

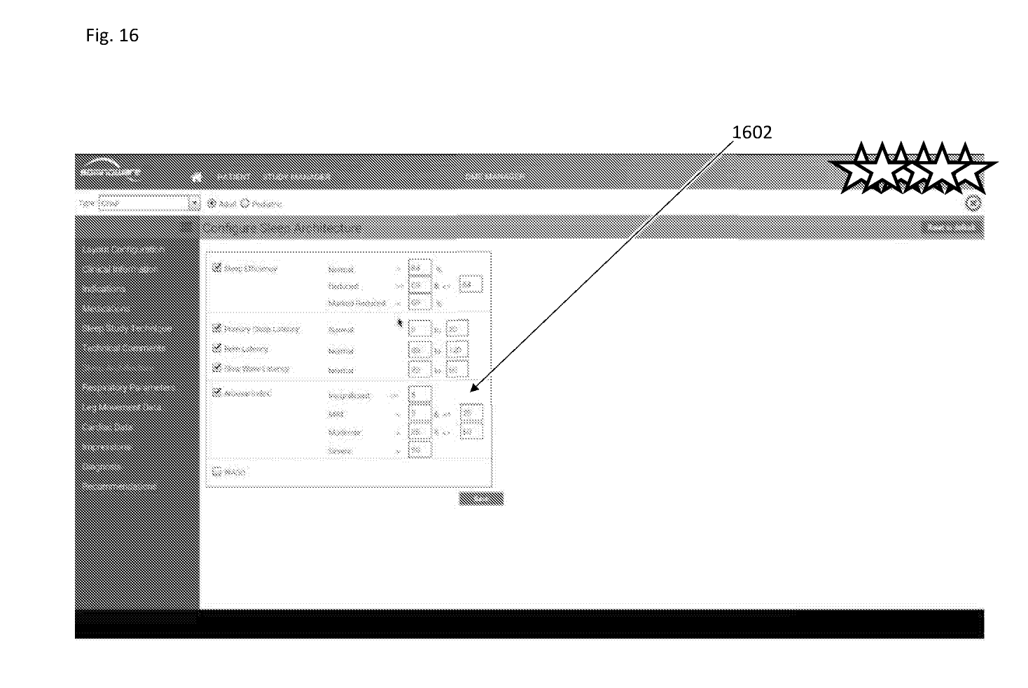

Exemplary FIG. 16 displays an exemplary embodiment of a threshold selection utility of a Physician Study Manager;

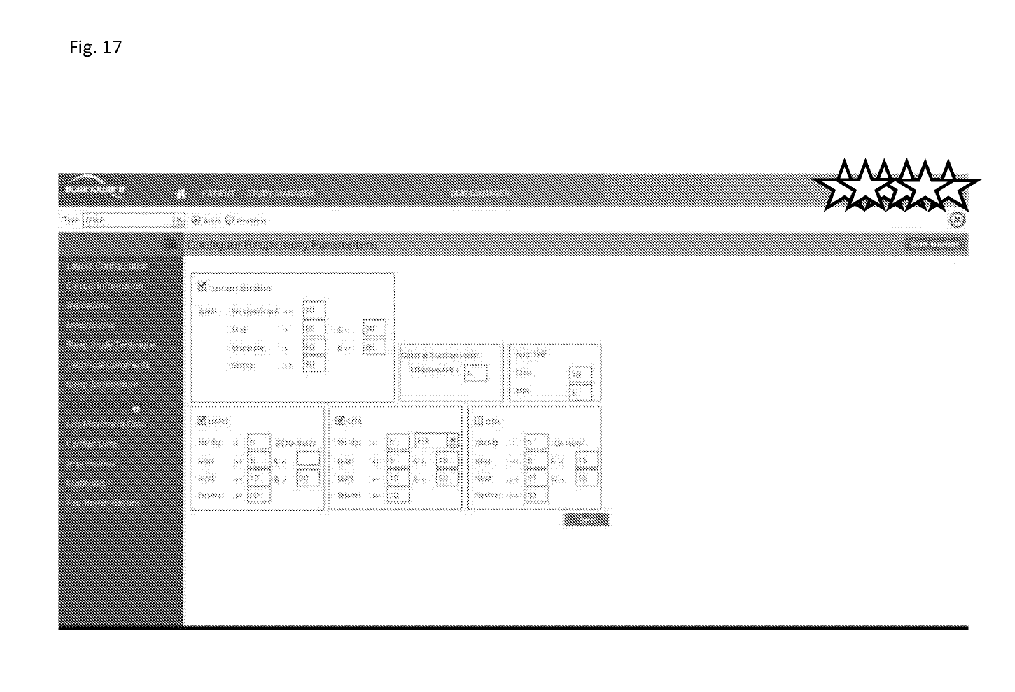

Exemplary FIG. 17 displays an exemplary embodiment of a threshold selection utility of a Physician Study Manager;

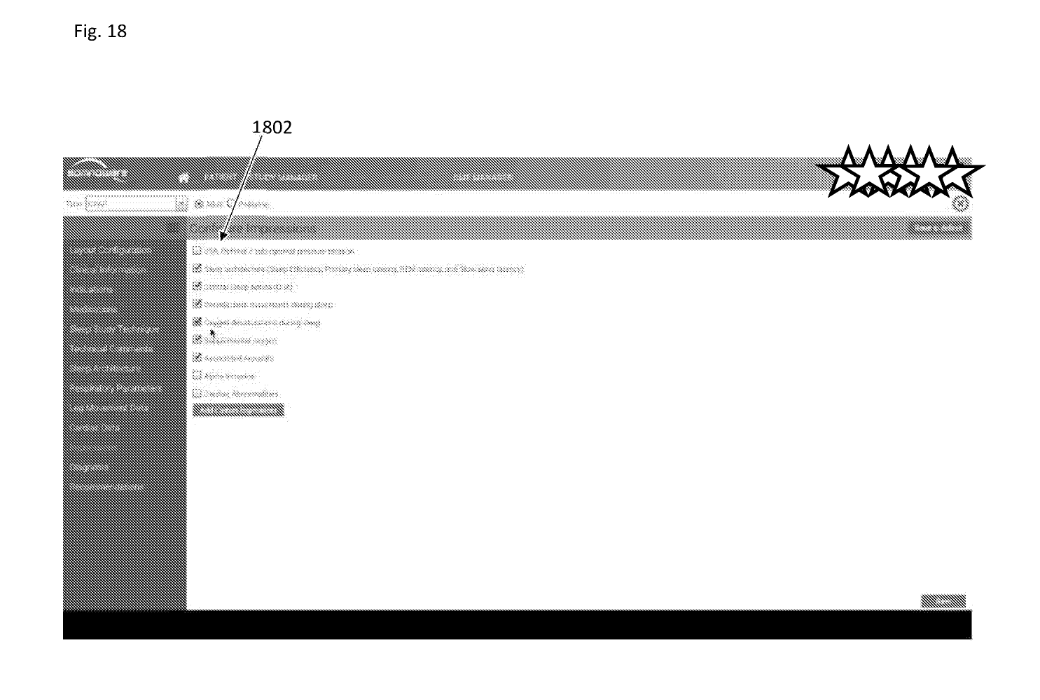

Exemplary FIG. 18 displays an exemplary embodiment of an impressions utility of a Physician Study Manager;

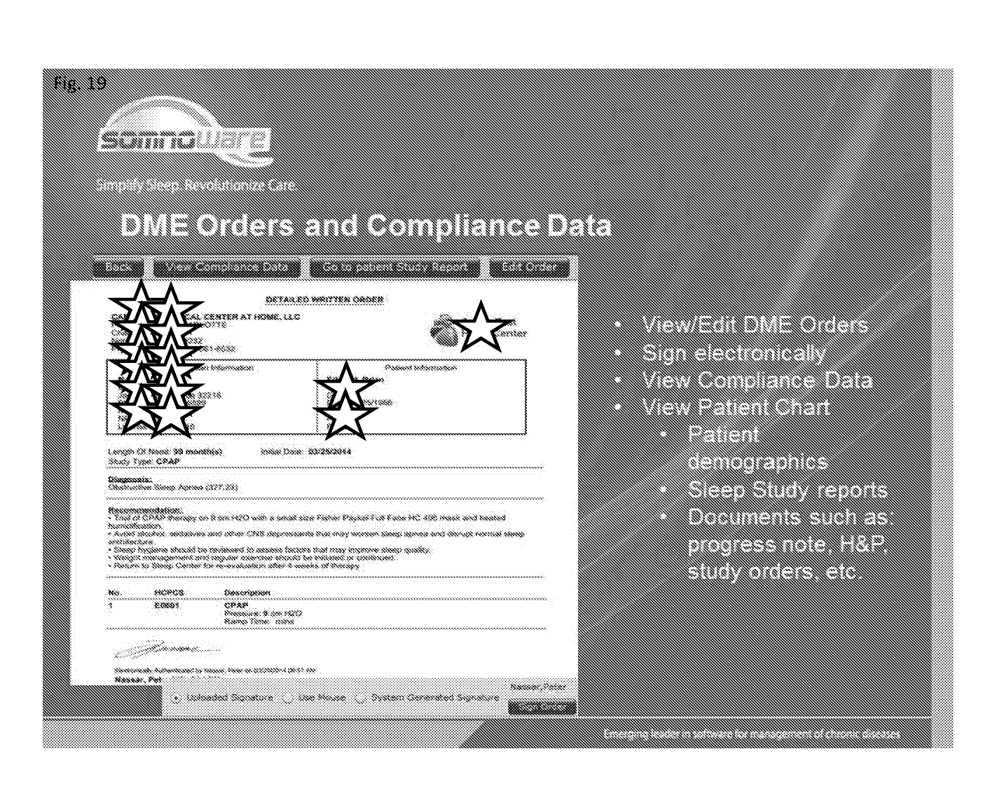

Exemplary FIG. 19 displays an exemplary embodiment of a Durable Medical Equipment selection and order utility of a Physician Study Manager;

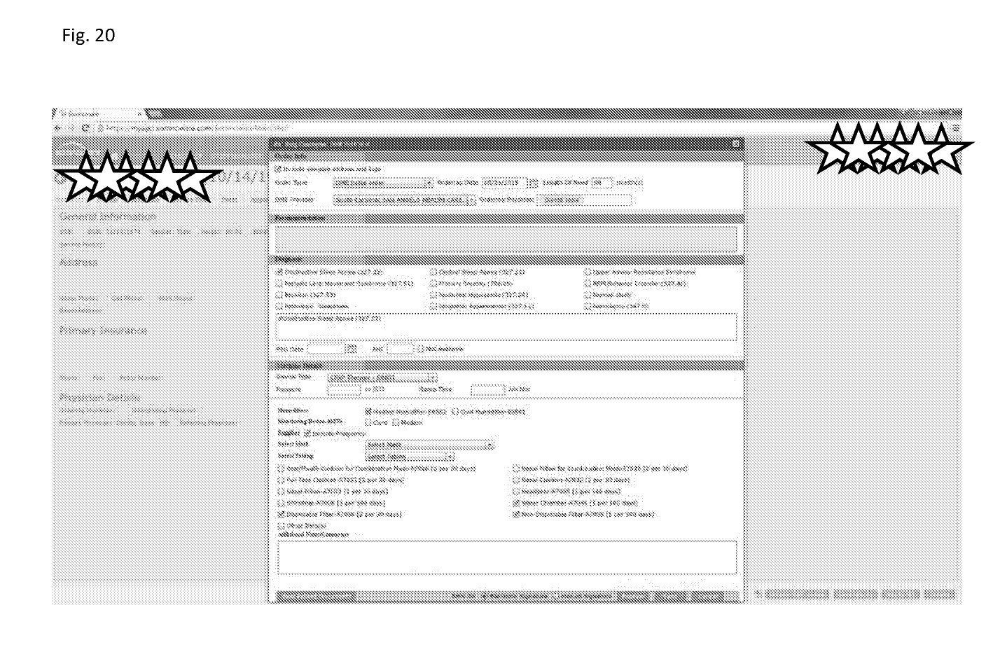

Exemplary FIG. 20 displays an exemplary embodiment of a Durable Medical Equipment selection and order utility of a Physician Study Manager;

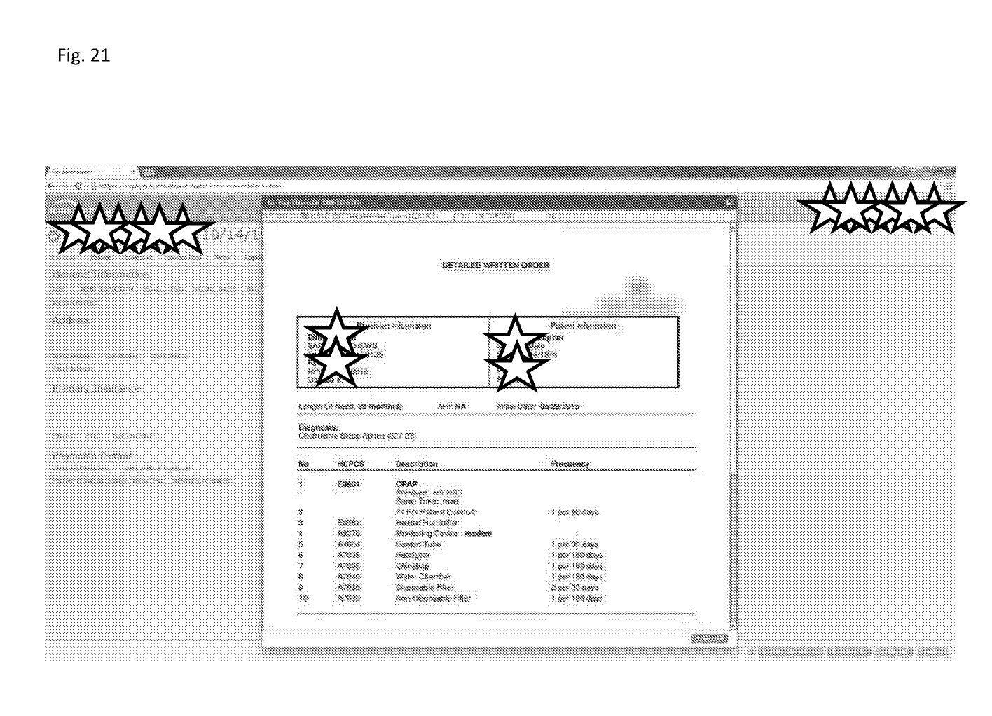

Exemplary FIG. 21 displays an exemplary embodiment of a Durable Medical Equipment selection and order utility of a Physician Study Manager;

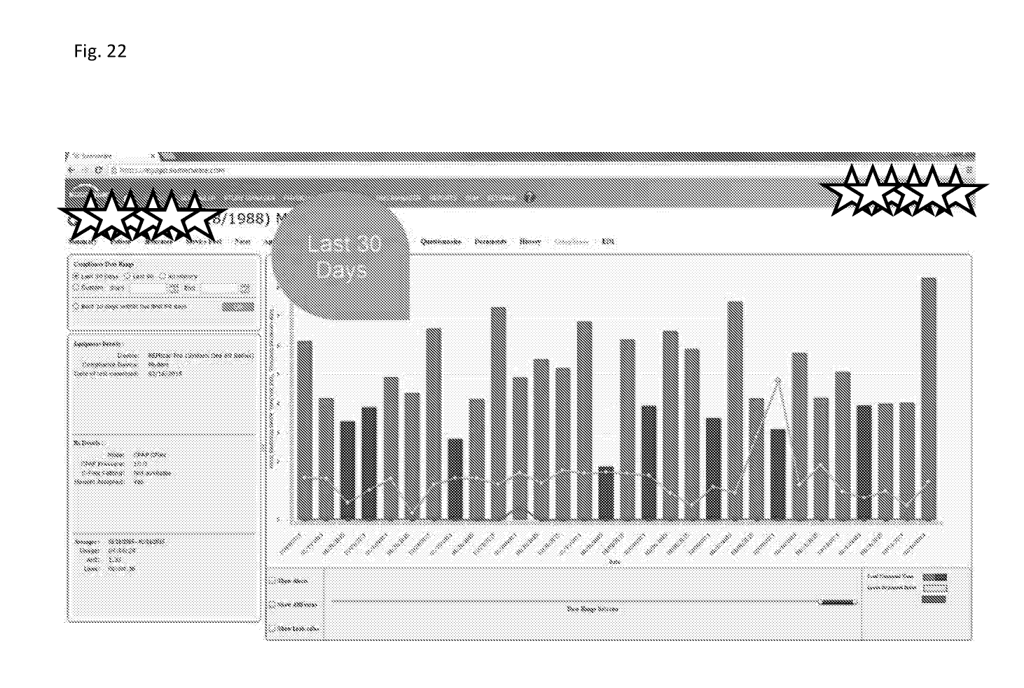

Exemplary FIG. 22 displays an exemplary embodiment of a statistical analysis utility of a Physician Study Manager;

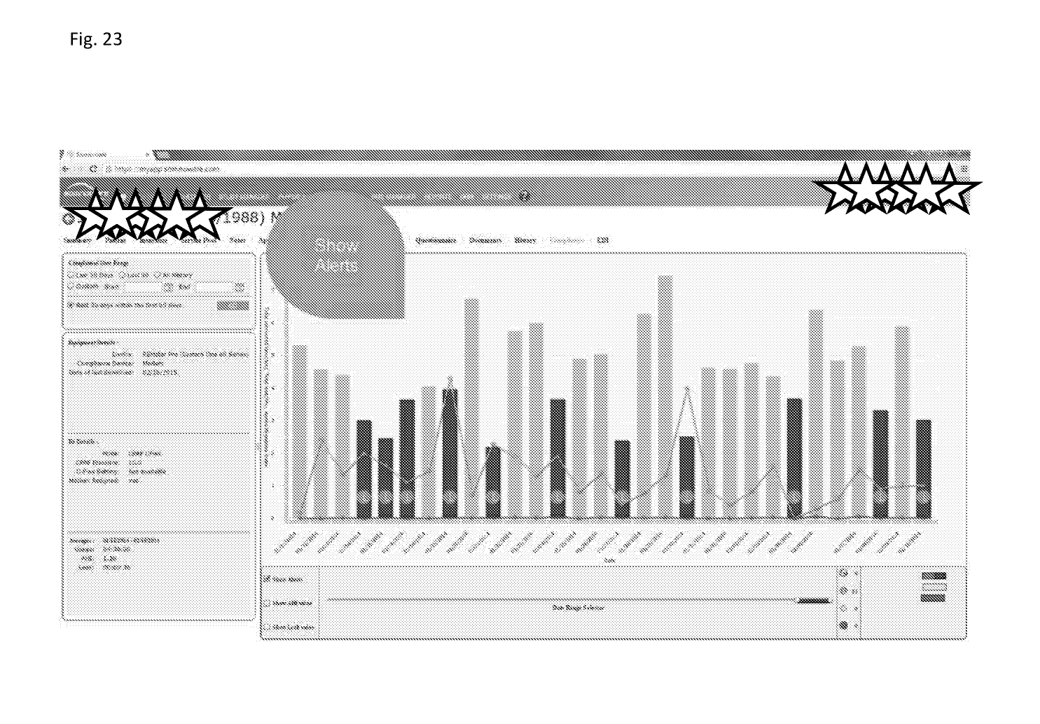

Exemplary FIG. 23 displays an exemplary embodiment of a statistical analysis utility of a Physician Study Manager;

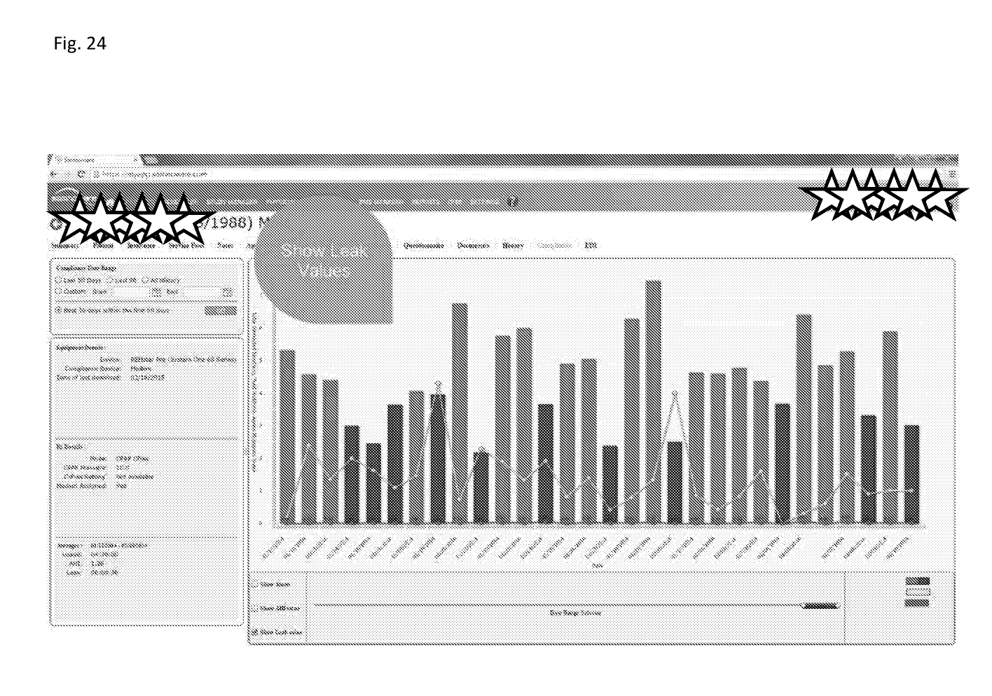

Exemplary FIG. 24 displays an exemplary embodiment of a statistical analysis utility of a Physician Study Manager;

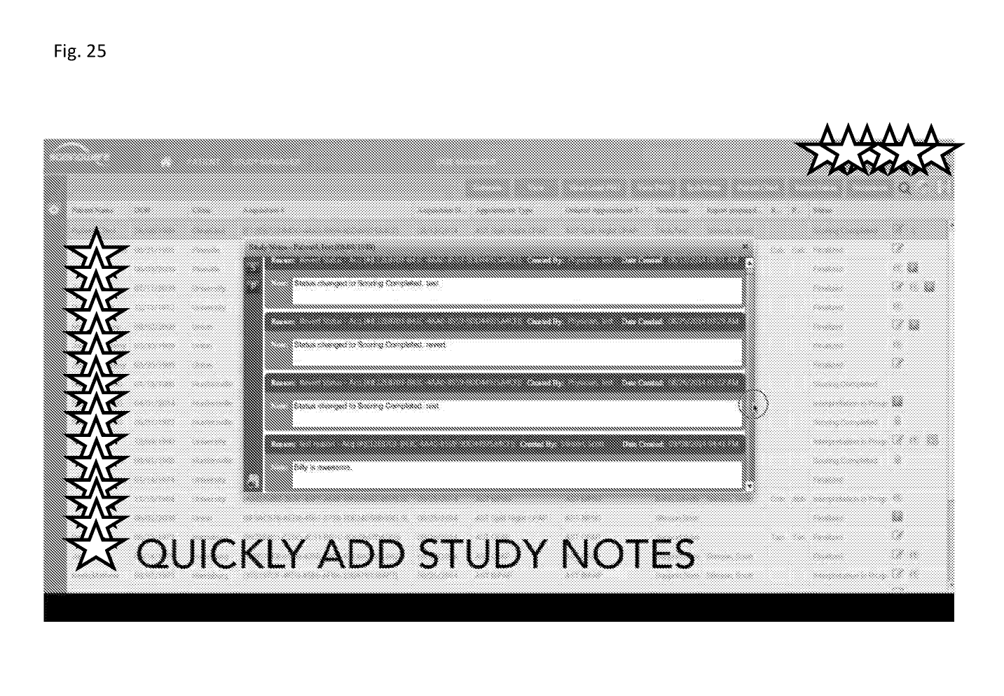

Exemplary FIG. 25 displays an exemplary embodiment and features of a notes utility of a Physician Study Manager;

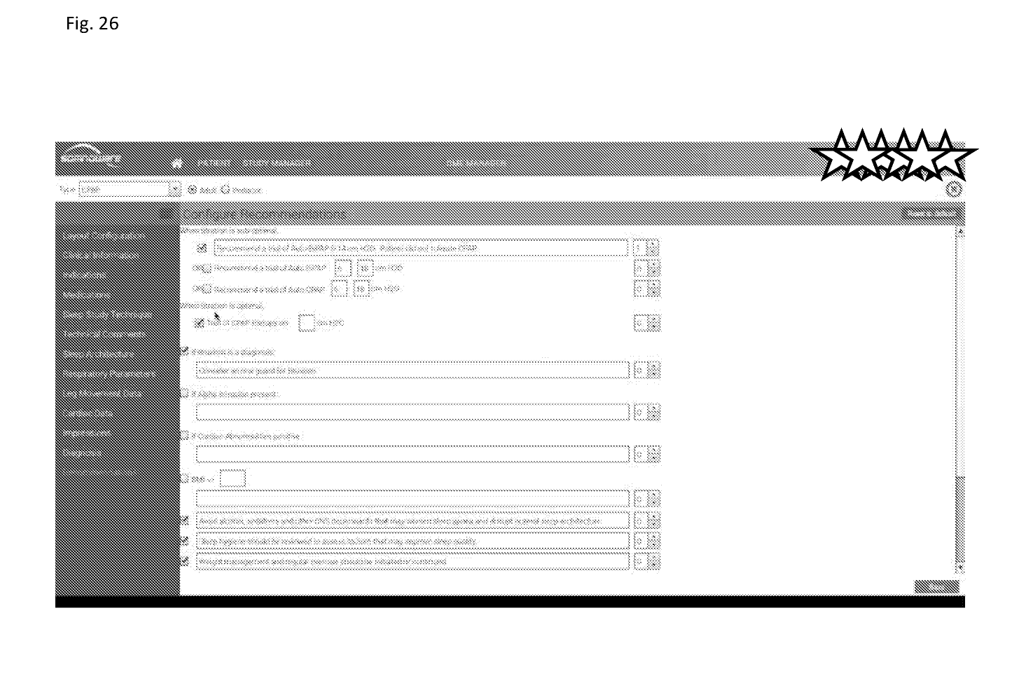

Exemplary FIG. 26 displays an exemplary embodiment of an algorithms utility of a Physician Study Manager.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein may be described in terms of sequences of actions to be performed by, for example, elements of a computing device. It should be recognized by those skilled in the art that the various sequence of actions described herein may be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

In an exemplary embodiment, the Physician Study Manager may function as a comprehensive medical workflow management system. The Physician Study Manager may operate as a platform for the diagnosis and treatment of a patient, for example within any medical field or medical sub-field, or within any other field involving customized treatment. The Physician Study Manager may also be a manager of a larger medical workflow process or software as a service product.

In an exemplary embodiment, a Physician Study Manager may be accessible by a web browser through an online portal, or through such other method of access as may be desired. In an embodiment, the Physician Study Manager may be remotely accessible from a plurality of computers, or from any properly configured computer, at any time. A user of the Physician Study Manager, such as a physician or medical professional or other authorized party, may have a unique username and a password that may be used to grant access to the system. Additionally, several physicians may operate the Physician Study Manager with a larger network of medical care providers. A specific physician may have a unique log-in id associated with a set of preferences, such that certain preferences may be custom-tailored to a specific physician. In an exemplary embodiment, other parties or devices may have access, or may have more limited access, to a Physician Study Manager; for example, in an exemplary embodiment, a technician, capable medical assessment device, or other entity may upload data related to a patient to the Physician Study Manager over a web portal. The data may be identified to a unique patient and may contain information, such as medical reports or other raw data (such as, for example, a sleep report) concerning the patient that may assist in diagnosing the patient. The data may be uploaded to the Physician Study Manager web portal or may be maintained locally on a user's computer. In an exemplary embodiment, a Physician Study Manager may additionally have full functionality on a singular computer that is not connected to a web portal, or may be fully functional on a local network. Users of the Physician Study Manager may generate and preview medical reports (such as sleep reports), raw data, or other information for each patient. The Physician Study Manager may additionally organize relevant video which may be viewed through the Physician Study Manager or when directly connected to a local network (such as a local network of a sleep center).

The Physician Study Manager may further allow users to view patient charts, which may include, for example, specific study reports, questionnaires, and documents corresponding to a particular patient. In an exemplary embodiment, the physician study manager may also be configured to extract data from patient charts and other documents, such as clinical reports that have been provided by other physicians or other sources and which provide data in a less than optimally usable form. For example, in an exemplary embodiment, a Physician Study Manager may perform quantitative data extraction (QDE) on a set of sleep physiological data, by running a QDE method on the data. This method may automatically extract quantitative data values from clinical reports or from other similar sources as may be desired. In an exemplary embodiment, a QDE process may run in the background of the Physician Study Manager interface, allowing a user to make use of the Physician Study Manager user interface while a QDE process is being run.

In an exemplary embodiment, a QDE process that may be operated in order to extract quantitative data from clinical reports or other documents may be device-agnostic. In an exemplary embodiment, such a process may be run on any computing device, or any computing device that may operate the Physician Study Manager user interface, as desired. In another exemplary embodiment, a user may be able to perform the QDE process on another machine not running the Physician Study Manager or the Physician Study Manager user interface; for example, in an exemplary embodiment, a medical services provider may designate one or more computers on a network to perform the QDE process in order to reduce hardware requirements of other computers on the network, if desired. Data extracted by the QDE process may be stored, for example in the Physician Study Manager or in a form accessible to the Physician Study Manager, as desired.

In an exemplary embodiment, charts and documents belonging to patients or otherwise associated with the Physician Study Manager may be sorted by a folder view, with parent folders and subfolders organized in a hierarchical manner. The documents may be displayed within the Physician Study Manager or the documents may be exported from the Physician Study Manager in a relevant or desired electronic or paper format.

Referring generally to FIGS. 1-6, an exemplary embodiment of a Physician Study Manager may be shown. In an exemplary embodiment, the Physician Study Manager may display a virtual dashboard when a user first accesses the system. As shown in, for example, FIG. 3, the dashboard may show a list of patients who have profiles in the system. The list of patients may display data associated with a list of patients; for example, an exemplary entry for a patient 302 may include information such as, but not limited to, the name of the patient, date of birth, referral type or other referral information (such as a name of a referring physician), an acquisition number and/or acquisition date (for example, the date that the patient was acquired as a client), an appointment type (which may include, for example a requested and an ordered appointment type), and a technician assigned to the patient. An exemplary entry for a patient 302 may also include a “scored by” section indicating one or more technicians or physicians who performed a medical test on the patient (such as, for example, generating an Apnea-Hypopnea Index (AHI) score for the patient), a “report prepared by” section indicating one or more parties who generated a report on a medical condition of the patient, a referring physician, an interpreting physician, a primary physician, the patient's insurance type, a number of pending days until the patient's next appointment, the status of the patient or of any tests requested to be run on the patient (for example, if an AHI score has been requested for the patient, if the patient's test results have yet to be interpreted, the patient's status may be “interpretation in progress,” and if the patient's test results have been interpreted already, the patient's status may be “scoring completed”), or any other indicators, as desired. In another embodiment, other information, such as a location of a clinic treating or referring the patient, any other information about an acquisition or appointment of the patient, or any other technician information may also be stored.

As shown in exemplary FIG. 6, the dashboard may additionally have an advanced patient search option 602 that may allow a user to search through the patient database by a name of a patient or other customizable search parameters. Additionally, the advanced patient search option 602 may allow for filtering by relevant criteria such as, but not limited to, the following: the patient name, a range of dates, a single date, a patient status, and a facility or location.

In an exemplary embodiment, for example as shown in FIG. 3, a dashboard may display a status indication of a patient 304 and sort patients by their status. The status of a patient's file may be indicated by a status indication 304, and patients' files may be marked as, for example, having an interpretation pending, having a finalized report, having a rejected data set or study, and other relevant status indications 304 of a last completed step of a patient in the workflow process. The status indications 304 may further be customizable to include any desired additional options or remove any desired aforementioned options. The user may additionally save a unique view or representation of the dashboard as the default view of the dashboard. The dashboard may initially have a default view in which patients are sorted by status.

Referring generally to FIGS. 7-12, an exemplary embodiment of a Physician Study Manager may be shown. In an exemplary embodiment, a Physician Study Manager may generate and issue a report for a patient. The report may be generated automatically or manually. The report may include the results of a statistical analysis of the data file of a patient. The report may display relevant patient information including, but not limited to, the following: the patient's identifying information (such as first and last name), the patient's demographic information (such as the patient's age), the technician that performed the study, the physician that interpreted the results, the patient's referring and primary care physicians, the patient's body mass index, the patient's weight, the specific type of study conducted, the types of diagnostic techniques and equipment used, technical comments from the technician, the patient's sleep architecture, the patient's respiratory parameters, the patient's leg movement data, the patient's cardiac data and impressions, and the patient's Epworth score.

The report may further be customizable to include any desired additional options or remove any desired aforementioned options. The report may be edited directly, or may, for example, be edited by an alternate tab, such as the alternate tab shown in exemplary FIG. 9, that may allow a user to navigate the report with additional features. The tab to edit the features may be utilized to freely manipulate text within report fields such as but not limited to the following: impressions, diagnostic information, and recommendations. The report may additionally feature drop down menus, checkboxes, radio buttons, or other electronic elements that may be toggled to assist with the population of relevant information into the report. When one of the aforementioned elements is toggled it may prepopulate data. The specific sections of the report may appear in any unique order or combination that a physician may prefer, and may be accompanied by any other relevant information; for example, in at least one exemplary embodiment, the technician's notes and the patient's full diagnostic PSG report may be included along with the selected sections of the report. A physician may desire to review the diagnostic report to check for data abnormalities or data points of interest.

Referring generally to FIGS. 13-15, an exemplary embodiment of a Physician Study Manager may be shown. According to an exemplary embodiment, a Physician Study Manager may provide a user with the ability to tailor a report to the specific preferences of the user. Preferences may be saved as, for example, a global setting, or may be set for each of several unique study types. For example, according to an exemplary embodiment, study types may include studies of adult and pediatric patients, each of which may have different preferences associated with them. The preferences may include information pertaining to but not limited to the following: the layout configuration of the report, clinical information relating to the patient, indications, medications, sleep study techniques, technical comments, sleep architecture, respiratory parameters, leg movement data, cardiac data, impressions, and diagnosis recommendations. As shown in exemplary FIG. 14, other information may be added by default, for example identifying and demographic information about the patient or an identification of the interpreting physician. The preferences may further be customizable to include additional options or remove aforementioned options.

Referring generally to FIGS. 16-17, an exemplary embodiment of a Physician Study Manager may be shown. In an exemplary embodiment of the Physician Study Manager, physicians may set customizable thresholds in the Physician Study Manager that may allow reports to be automatically generated with specifically relevant and customizable information. In an exemplary embodiment, a Physician Study Manager may have more than one set of thresholds that can be set. For example, exemplary FIG. 16 may show a utility in which a physician can set a number of thresholds having to do with a patient's sleep architecture; for example, a physician may set a threshold for each of several tiers of a patient's arousal index, with an arousal index of five or less indicating an insignificant amount of sleep disruption, an arousal index between 5 and 25 indicating a mild amount of sleep disruption, an arousal index of between 25 and 50 indicating a moderate amount of sleep disruption, and an arousal index of above 50 indicating a severe amount of sleep disruption. Exemplary FIG. 17 may show similar thresholds for a patient's respiratory parameters; other thresholds may be set for other test parameters, as desired. These thresholds may save the physician time, increase the accuracy of reporting, and eliminate significant amounts of repetitive editing.

In an exemplary embodiment, threshold values may be used in conjunction with other rules. For example, according to an exemplary embodiment, a Physician Study Manager may perform rule-based auto-tagging of patient data or data sets, based on threshold values (which may be globally set or set for a particular patient, as desired) and based on a patient's physiological data. This may allow for quick segmentation of studies and tasks, saving time. For example, in an exemplary embodiment, a particular user-specific threshold for a particular patient may be set, and the Physician Study Manager may then tag all of the patient's data that represents a value that is outside of that threshold. The Physician Study Manager may then allow tagged portions of a patient's data to be specifically browsable and selectable, highlighting data regions of greatest interest and saving physician time.

In an exemplary embodiment, physicians may be able to freely text edit the tabular and narrative sections of the report natively within the Physician Study Manager. The section layouts of the report may additionally be modified to display, in a user defined order, the various sections of the report. Accordingly, the report may be highly customized to any desired preferences of a physician. The physician may electronically sign and verify the report to authenticate it. The signature may be time and date stamped. A user may edit the pertinent thresholds of the sleep architecture, and respiratory parameters of a diagnostic test to assist the physician in determining an accurate diagnoses. The criteria relevant to a patient's sleep architecture may include, for example, the patient's sleep efficiency, primary sleep latency, REM latency, slow wave latency, and arousal index. Criteria relevant to a patient's respiratory index may include, for example, the patient's oxygen saturation, the patient's optimal titration value, the patient's Auto PAP, the patient's UARS, the patient's OSA, or the patient's CSA, or any other criteria, as desired. These thresholds may be input by a percentage, ratio, fixed amount, or other relevant criteria. In some exemplary embodiments, these thresholds may indicate normal, reduced, or markedly reduced information. Additionally, thresholds for insignificant, mild, moderate, and severe percentages may be user defined.

Referring generally to FIG. 18, an exemplary embodiment of a Physician Study Manager may be shown. In an exemplary embodiment of the Physician Study Manager, a user may configure impression statements 1802, such as those shown, in order to eliminate redundant typing. In an exemplary embodiment, the Physician Study Manager may save and store pre-typed text that may be used to pre-populate specific sections. The text may be recalled as a default input for an impression. Configurable impressions may include, but are not limited to, the following: OSA optimal and sub-optimal titration, sleep architecture, sleep efficiency, primary sleep latency, REM latency, and slow wave latency, central sleep apnea, periodic limb movements during sleep, oxygen destructions during sleep, supplemental oxygen, associated arousals, alpha intrusion, and cardiac abnormalities. Additionally, a user may add any desired custom impressions. Adding or removing an impression from a report may be accomplished by, for example, drop down menus, checkboxes, radio buttons, or other electronic elements that may be toggled such that when selected will display or remove the text of the impression. The electronic elements of the programmable impressions may greatly save the physician time, eliminate repetitive typing and redundancy. Furthermore, it may increase the accuracy of the report.

Referring generally to FIGS. 19-20, an exemplary embodiment of a Physician Study Manager may be shown. An exemplary embodiment of a Physician Study Manager may include a utility allowing a request for durable medical equipment to be made; in an exemplary embodiment, a request for durable medical equipment may be made in a field of entry within the Physician Study Manager, or through another utility, as desired.

In an embodiment, in order to request durable medical equipment, a user may open an order for durable medical equipment for a patient, and may then be able to add or edit information on an order form. In an exemplary embodiment, an order form may feature drop down menus, checkboxes, radio buttons, or other electronic elements that may be toggled in order to add or edit information or edit the placement of information. Information in the order form may be organized into a first group of sections, such as a section covering order info (such as the type and date of the order), a diagnosis section, a section providing details about the machine or other article of durable medical equipment to be ordered, and additional notes/comments and recommendations of any user. The first group of sections may be customizable to contain additional sections. The sections may include drop down menus, checkboxes, radio buttons, or other electronic elements that may further contain customizable inputs. The order info section may include drop down menus, checkboxes, radio buttons, or other electronic elements in which a user may be able to specify certain information relevant to the order, such as the order type, ordering date, length of need, the durable medical equipment provider, or the ordering physician. The diagnosis section may include drop down menus, checkboxes, radio buttons, or other electronic elements, and may allow a user to specify a diagnosis of the patient, such as obstructive sleep apnea, periodic limb movement syndrome, bruxism, pathologic sleepiness, central sleep apnea, primary snoring, nocturnal, hypoxemia, idiopathic hypersomnia, upper airway resistance syndrome, REM behavior disorder, normal study, or narcolepsy, which may be relevant to the order. The machine details section may include drop down menus, checkboxes, radio buttons, or other electronic elements by which a user may specify, for example, certain attributes of an article of durable medical equipment to be ordered, including the device type, pressure, ramp time, humidifiers, monitoring device, type of mask that should be used in the device, and type of tubing that should be used. A user may also be able to specify one or more additional items that may be included with the article, such as, for example, an oral or mouth cushion for combination mask, full face cushions, a nasal pillow, a chinstrap, disposable filter, a nasal pillow for a combination mask, a nasal cushion, headgear, a water chamber, and a non-disposable filter, or any other items as may be desired.

Referring generally to FIG. 21, an exemplary embodiment of a Physician Study Manager may be shown. In an exemplary embodiment, a Physician Study Manager may provide a utility in which a user may open a request for durable medical equipment; durable medical equipment may include, for example, sleep assistive devices and sleep assessment devices for testing. In an exemplary embodiment, a Physician Study Manager may offer different permissions to a user based on the user's credentials and authority; for example, in an exemplary embodiment, a Physician Study Manager may allow a technician to prepare a request, but may require a physician to approve the request before the request is communicated. The request may optionally originate from the physician or an alternate designated user of the Physician Study Manager for approval of an external entity; for example, in an exemplary embodiment, a request may be shared directly with an insurance company that may provide for full or partial fund re-imbursement of the medical equipment. The request may be shared directly with a durable medical equipment provider as an order form and authorization. The requests may be sent to a physician for approval electronically or it may be printed and mailed or faxed.

Referring generally to FIGS. 22-24, an exemplary embodiment of a Physician Study Manager may be shown. In an exemplary embodiment, a Physician Study Manager may be configured to perform statistical analysis on information available to it; for example, in an exemplary embodiment, a Physician Study Manager may perform a statistical analysis of the patient's information. In an exemplary embodiment, the analysis portion of the management system may be configured to perform any of a variety of statistical functions such as sorting of the data, normalization, best fit, averaging, and other common statistical analysis methods known in the art. The Physician Study Manager may additionally perform other statistical manipulations, and may be configured to, for example, display all patient information that has been generated within the last 90 days, display all patient information from within the last 30 days, display all patient information within a customizable range of dates, display the best patient data within a range of days, show the AHI values, and Leak Values.

Referring generally to FIG. 25, an exemplary embodiment of a Physician Study Manager may be shown. In an exemplary embodiment of a Physician Study Manager, a Physician Study Manager may allow users to input notes directly to a patient's data file. In an embodiment, the note section of a data file may be separate from the traditional note section of a patient's chart. In some exemplary embodiments, these notes may be kept separate from medical administrators, schedulers, and other support staff and may be recorded by the technician for the physician, or they may be recorded by the physician for the technician. The notes may feature other security elements; for example, in some exemplary embodiments, viewing of the notes may be restricted to parties with some credential, and may be, for example, password protected or permission based, or may be otherwise protected by another method desired or known in the art. In such an embodiment, the customizable security checks of the notes may prevent unauthorized entities from viewing the text of the notes. The notes may additionally be useful for, and may be provided to, other outside medical entities or insurance agencies. Universal notes may also be utilized that feature minimal security checks in the event that the text is intended for schedulers, support staff, and other relevant entities' on a non-secured basis.

Referring generally to FIG. 26, an exemplary embodiment of a Physician Study Manager may be shown. In an exemplary embodiment of a Physician Study Manager the Physician Study Manager may use programmable algorithms to insert the appropriate diagnoses, impressions, and recommendations into a report. The algorithms may represent an intelligent computer implemented method in which all desired data, and its relevant derivatives, are assembled into a comprehensive report. The report may be tailored to be brief in nature or thorough dependent on the user defined inputs. The algorithms may draw upon variables such as user defined parameters, industry standard parameters, other parameters established by the Physician Study Manager, and other variables contained within the broader Physician Study Manager network. The algorithms may further perform a series of steps according to user defined conditional statements. These conditional statements may be represented by an if/then statement that a user of the Physician Study Manager may provide. The algorithms may be established by unique preferences of a user such that the algorithm is capable of compiling the appropriate diagnoses, impressions, and recommendations on the final reports. The algorithms can assist in the automation of the report generation. An input may be the statistical features and analysis of the Physician Study Manager or an input may be a physician established threshold or groups of thresholds. The inputs may be established by industry standards or other default parameters in combination with user defined parameters. The Physician Study Manager may compare input parameters such as Titration Sub Optimality, Bruxism, Alpha Intrusion, Cardiac Abnormalities, and BMI from a patients data file to the physician established thresholds. In at least one exemplary embodiment, if the thresholds are exceeded a pre-populated message may be inserted into the report. Examples of the aforementioned inputs are meant to be illustrative rather than restrictive.

In some exemplary embodiments, the algorithm may refer to an ability of the Physician Study Manager to utilize rule based insertion of custom sentences into the report, depending on the clinical metrics obtained from the sleep study. As an example, a physician may configure: If AHI<5: “Patient is normal. As an example, a physician may configure: If AHI>=5 and AHI<15: “Patient has mild sleep apnea.” As an example, a physician may configure: If AHI>=15 and AHI<30: “Patient has moderate sleep apnea.” As an example, a physician may configure: If AHI>=30: “Patient has severe sleep apnea.” Because the thresholds are customizable, another physician may set different thresholds for the AHI, thereby allowing the algorithm to pre-populate data at different thresholds for the same diagnoses. The Physician Study Manager may additionally utilize several if/then conditional statements that may be configured by the physician in the Physician Study Manager to insert custom diagnosis/comments in the final interpretation report. Examples, of the aforementioned thresholds are meant to be illustrative rather than restrictive.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments may be made by those skilled in the art without departing from the scope of the invention as defined by the following claims.

What is claimed is:

1. A computer-implemented health data management system, comprising a computer having a processor and a memory and implementing a physician study management portal accessible by a credentialed user from a standard browser, the memory being a non-transitory computer readable medium comprising code executable by a computer and arranged to cause the computer to carry out the following steps:
receiving, via a Web portal, medical data of a patient;
matching, with a processor, the medical data of the patient with a profile of the patient, and associating the medical data and the profile of the patient in the memory;
identifying, with a processor, a status indication of the profile of the patient, the status indication providing an indication of the status of one or more medical tests conducted on the patient;
when the status indication indicates that at least one of the medical tests conducted on the patient has yet to be interpreted by a physician, identifying, with a processor, a physician of the patient, and displaying, on a display, a medical test result of a patient;
receiving, from a user interface, an interpretation of a medical test result;
updating, with a processor, the status indication of the profile of the patient; and
generating and issuing a report for the patient comprising the medical data of the patient and the interpretation of the medical test result.

2. The computer-implemented health data management system of claim 1, further comprising:
receiving, from a user interface, one or more threshold values for medical data, wherein medical data values below the threshold values are associated with a first result and medical data values above the threshold values are associated with a second result;
automatically calculating, with a processor, whether one or more quantitative medical data values fall above or below the one or more threshold values; and
automatically updating a report with a first result or a second result.

3. The computer-implemented health data management system of claim 2, further comprising:
with a processor, automatically identifying a set of data values of the medical data falling outside of the one or more threshold values for medical data; and
in the memory, associating the set of data values falling outside of the one or more threshold values with a tag.

4. The computer-implemented health data management system of claim 3, further comprising:
receiving, from a user interface, a selection of one or more tags to be displayed on the user interface; and
with a processor, updating the user interface to display a set of data values associated with a tag in the selection of one or more tags.

5. The computer-implemented health data management system of claim 1, further comprising:
receiving, from a user interface associated with a user, a request to provide one or more articles of durable medical equipment;
verifying, with a processor, a credential of the user; and
sending the request, via electronic network communication, to another party after the credential of the user has been verified.

6. The computer-implemented health data management system of claim 5, further comprising:
automatically generating, with a processor, an order form for durable medical equipment; and
automatically populating, with a processor, the order form with information from the profile of the patient.

7. The computer-implemented health data management system of claim 5, wherein the user comprises a technician associated with the profile of the patient, and wherein the step of sending the request to another party comprises sending the request to a physician associated with the profile of the patient; and further comprising:
receiving, from a user interface, an authorization of the physician;
verifying, with a processor, a credential of the physician; and
marking the request with a unique identifier of the physician indicating that the request has been authorized by the physician.

8. The computer-implemented health data management system of claim 1, wherein the step of generating and issuing a report for the patient further comprises:
receiving, from a user interface, at least one selection indicating a report content preference; and
updating, with a processor, the report to match the report content preference.

9. The computer-implemented health data management system of claim 1, wherein the step of generating and issuing a report for the patient further comprises:
receiving, from a user interface, at least one selection indicating a report presentation preference; and
updating, with a processor, the report to match the report presentation preference.

10. The computer-implemented health data management system of claim 1, wherein the step of generating and issuing a report for the patient further comprises generating, with a processor, at least one statistical manipulation of the medical test result of the patient.

11. The computer-implemented health data management system of claim 1, further comprising:
receiving, from a user interface, a note to be added to a file of a patient;
updating, with a processor, the file of the patient to include the note; and
restricting access to the note based on a credential of a user.

12. The computer-implemented health data management system of claim 1, further comprising:
identifying, with a processor, from the profile of the patient, a referring physician; and
providing a login credential to the referring physician, the login credential configured to allow the referring physician access to the profile of the patient.

13. The computer-implemented health data management system of claim 1, further comprising:
with a processor, extracting one or more quantitative data values from the medical data of the patient; and
in the memory, updating the medical data of the patient to include the one or more quantitative data values.

14. A method for management of medical data, comprising:
uploading, from a user interface, to a computer-implemented health data management system comprising a processor and a memory, medical data of a patient;
wherein the health data management system is configured to:
match, with the processor of the health data management system, the medical data of the patient with a profile of the patient, and associating the medical data and the profile of the patient in the memory of the health data management system;
identify, with the processor, a status indication of the profile of the patient, the status indication providing an indication of the status of one or more medical tests conducted on the patient; and
when the status indication indicates that at least one of the medical tests conducted on the patient has yet to be interpreted by a physician, identify, with a processor, a physician of the patient, and displaying, on a display, a medical test result of a patient;
uploading, from a user interface, to the health data management system, an interpretation of a medical test result;
wherein the health data management system is further configured to:
update, with the processor, the status indication of the profile of the patient; and
generate and issue a report for the patient comprising the medical data of the patient and the interpretation of the medical test result.

15. The method of claim 14, further comprising:
uploading, from a user interface, to the health data management system, one or more threshold values for medical data, wherein medical data values below the threshold values are associated with a first result and medical data values above the threshold values are associated with a second result;
wherein the health data management system is further configured to:
automatically calculate, with the processor, whether one or more quantitative medical data values fall above or below the one or more threshold values; and
automatically update a report with a first result or a second result.

16. The method of claim 15, wherein the health data management system is further configured to:
automatically identify, with the processor, a set of data values of the medical data falling outside of the one or more threshold values; and
in the memory, associating the set of data values falling outside of the one or more threshold values with a tag.

17. The method of claim 16, further comprising:
transmitting, from a user interface, a selection of one or more tags; and
wherein the health data management system is further configured to:
update, on the user interface, a set of data values associated with a tag in the selection of one or more tags.

18. The method of claim 14, further comprising:
uploading, from a user interface, to the health data management system, a request to provide one or more articles of durable medical equipment, the request being associated with a specific user;
wherein the health data management system is further configured to:
verify, with a processor, a credential of the user; and
send the request, via electronic network communication, to another party after the credential of the user has been verified.

19. The method of claim 18, wherein the user comprises a technician associated with the profile of the patient, and wherein the step of sending the request to another party comprises sending the request to a physician associated with the profile of the patient; and further comprising:
uploading, from a user interface, to the health data management system, an authorization of the physician;
wherein the health data management system is further configured to:
verify, with a processor, a credential of the physician; and
mark the request with a unique identifier of the physician indicating that the request has been authorized by the physician.

20. The method of claim 14, further comprising:
uploading, from a user interface, to the health data management system, at least one selection indicating a report content preference; and
wherein the health data management system is further configured to update, with the processor, the report to match the report content preference.

21. The method of claim 14, further comprising:
uploading, from a user interface, to the health data management system, at least one selection indicating a report presentation preference; and
wherein the health data management system is further configured to update, with the processor, the report to match the report presentation preference.

22. The method of claim 14, further comprising:
sending a request, from a user interface, to the health data management system, for at least one statistical manipulation of the medical test result of the patient to be performed by the health data management system; and
wherein the health data management system is further configured to perform the at least one statistical manipulation and update the report to include the at least one statistical manipulation.

23. The method of claim 14, further comprising:
uploading, from a user interface, to the health data management system, at least one note to be added to a file of a patient; and
wherein the health data management system is further configured to update, with the processor, the file of the patient to include the note, and to restrict access to the note based on a credential of a user.

24. The method of claim 14, wherein the health data management system is further configured to:
identify, with the processor, from the profile of the patient, a referring physician; and
provide a login credential to the referring physician, the login credential configured to allow the referring physician access to the profile of the patient.

25. The method of claim 14, wherein the health data management system is further configured to:
with a processor, extract one or more quantitative data values from the medical data of the patient; and
in the memory, update the medical data of the patient to include the one or more quantitative data values.

26. A computer-implemented health data management apparatus, comprising a computer having a processor and a memory and implementing a physician study management utility accessible by a credentialed user from a user interface, the memory being a non-transitory computer readable medium comprising code executable by a computer and arranged to cause the computer to carry out the following steps:
receiving, on the health data management apparatus, from a local network, medical data of a patient;
matching, with the processor, the medical data of the patient with a profile of the patient, and associating the medical data and the profile of the patient in the memory;
identifying, with the processor, a status indication of the profile of the patient, the status indication providing an indication of the status of one or more medical tests conducted on the patient;
when the status indication indicates that at least one of the medical tests conducted on the patient has yet to be interpreted by a physician, identifying, with the processor, a physician of the patient; displaying, on a display of the apparatus, a request for the input of the physician of the patient; authenticating, with the processor, a credential of the physician of the patient; and displaying, on a display of the apparatus, a medical test result of a patient;
receiving, from the user interface, an interpretation of a medical test result;
updating, with the processor, the status indication of the profile of the patient;
generating and issuing a report for the patient comprising the medical data of the patient and the interpretation of the medical test result; and
sharing the report on the local network.
